(19) United States
(12) Patent Application Publication
(10) Pub. No.: US 2014/0314985 A1
(43) Pub. Date: Oct. 23, 2014

(54) Platinum-catalyzed Condensation-cure Silicone Systems

(71) Applicant: 3M INNOVATIVE PROPERTIES COMPANY, St.Paul, MN (US)

(72) Inventors: Jitendra S. Rathore, Woodbury, MN (US); Maria A. Appeaning, St. Paul, MN (US); Larry D. Boardman, Woodbury, MN (US); Michele A. Craton, Cottage Grove, MN (US)

(73) Assignee: 3M INNOVATIVE PROPERTIES COMPANY, St. Paul, MN (US)

(21) Appl. No.: 14/366,057

(22) PCT Filed: Dec. 20, 2012
(86) PCT No.: PCT/US2012/070809

§ 371 Date: Jun. 17, 2014

Related U.S. Application Data
(60) Provisional application No. 61/578,039, filed on Dec. 20, 2011.

(51) Int. Cl. C08G 77/20; C09J 7/02

(52) U.S. Cl. CPC C08G 77/20; C09J 7/0228
USPC 428/41.8; 528/10

(57) ABSTRACT

Condensation-cure systems comprising at least one silanol-functional polyorganosiloxane and a platinum catalyst are described. The platinum catalysts include Pt(0) complexes, a Pt(II) complexes, and a Pt(IV) complexes. Condensation-cure systems comprising two or more silanol-functional polyorganosiloxanes are described, as are systems comprising a silanol functional polyorganosiloxane in combination with hydride-functional silanes or alkoxy-functional silanes. Articles incorporating cured condensation-cure systems are also disclosed.

### FIELD

The present disclosure relates to condensation-cure silicone systems. In particular, the disclosure relates to the use of platinum complexes as catalysts for such systems.

### SUMMARY

Briefly, in one aspect, the present disclosure provides a condensation-cure system comprising at least one silanol-functional polyorganosiloxane and a platinum catalyst. In some embodiments, the platinum catalyst comprises at least one of a Pt(0) complex, a Pt(II) complex, and a Pt(IV) complex. In some embodiments, the condensation-cure system comprises two or more silanol-functional polyorganosiloxanes. In some embodiments, the condensation-cure system comprises a hydride-functional silane. In some embodiments, the condensation-cure system comprises an alkoxy-functional silane.

In another aspect, the present disclosure provides an article comprising a crosslinked silicone layer comprising the reaction product of the condensation-cure system according to any of the various embodiments of the present disclosure. In some embodiments, the article comprises a substrate and the crosslinked silicone layer covers at least a portion of a first surface of the substrate. In some embodiments, the article further comprises an adhesive layer, wherein the adhesive layer covers at least a portion of the crosslinked silicone layer.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an exemplary release article according to some embodiments of the present disclosure.

FIG. 2 illustrates an exemplary adhesive article according to some embodiments of the present disclosure.

### DETAILED DESCRIPTION

Curable silicone materials are useful in a variety of applications. For example, some curable silicone systems can be used to prepare release materials, e.g., release coatings for adhesives including, e.g., pressure sensitive adhesives. Silicone systems have been prepared using a variety of approaches, including addition-cure and condensation-cure chemistries.

Addition-cure refers to a system where curing is achieved through the addition of Si—H across a pi (π) bond, i.e., hydrosilation. One advantage of addition-cure systems is that precious metal catalysts (e.g., platinum catalysts) are exceptionally efficient, e.g., even with low parts per million (ppm) of platinum, the hydrosilylation reaction can occur rapidly without producing by-products. Both thermal-cure and radiation-cure, precious metal catalysts have been used in addition-cure (i.e., hydrosilation) silicone systems.

Condensation cure refers to a system where curing is achieved through the reaction of Si—OH and Si—H groups or Si—OH and Si—OH groups leading to the formation of Si—O—Si linkages and hydrogen gas or water. Exemplary condensation-cure silicone systems include those comprising hydroxyl-functional polyorganosiloxane(s) and hydride-functional silane(s). Typically, condensation-cure silicone systems have been cured with tin catalysts. Tin-based catalysts catalyze two major reactions, i.e., chain-extension reactions involving two silanol groups, and cross-linking or curing reactions involving a silanol group and a silicon hydride group.

The present inventors have surprisingly discovered that platinum complexes, including Pt(0), Pt(II), and Pt(IV) complexes, can replace tin as a catalyst for condensation-cure silicone systems.

Generally, the compositions of the present disclosure comprise a condensation-cure silicone system and a catalyst comprising a platinum complex, e.g., a Pt(0), Pt(II) or Pt(IV) complex. In some embodiments, the silicone system comprises a hydroxyl-functional polyorganosiloxane and a hydride-functional silane. Generally, the hydride-functional silane comprises at least two, and in some embodiments three or more silicon-bonded hydrogen atoms.

Generally, any known hydroxyl-functional polyorganosiloxane suitable for use in condensation-cure systems can be used in the compositions of the present disclosure, and such materials are well-known and readily obtainable. Exemplary polyorganosiloxanes include poly(dialkylsiloxane) (e.g., poly(dimethylsiloxane)), poly(diarylsiloxane) (e.g., poly(diphenylsiloxane)), poly(alkylarylsiloxane) (e.g., poly(methylphenylsiloxane)) and poly(dialkyldiarylsiloxane) (e.g., poly(dimethyldiphenylsiloxane). Both linear and branched polyorganosiloxanes may be used. In some embodiments, one or more of the organo groups may be halogenated, e.g., fluorinated.

Exemplary hydroxyl-functional polyorganosiloxanes include silanol-terminated polydimethylsiloxanes including, e.g., those available from Gelest, Inc., Morrisville, Pa., including those available under the trade names DMS-S12, -S14, -S15, -S21, -S27, -S31, -S32, -S33, -S35,-S42, -S45, and -S51; and those available from Dow Corning Corporation, Midland, Mich., including those available under the trade names XIAMETER OHX Polymers and 3-0084 Polymer, 3-0113 Polymer, 3-0133 Polymer, 3-0134 Polymer, 3-0135 Polymer, 3-0213 Polymer, and 3-3602 Polymer.

In some embodiments, the composition may comprise an alkoxy-functional polydiorganosiloxane that is converted to a hydroxyl-functional polyorganosiloxane in situ, e.g., upon exposure to water. Exemplary alkoxy-functional polydiorganosiloxanes include DMS-XE ethoxy terminated polydimethyl siloxane and DMS-XM11 methoxy terminated polydimethylsiloxane, available from Gelest, Inc.

Generally, any known hydride-functional silane suitable for use in condensation-cure systems can be used in the compositions of the present disclosure, and such materials are well-known and readily obtainable. Exemplary hydride-functional silanes include those available from Dow Corning Corporation, including those available under the trade name SYL-OFF (e.g., SYL-OFF 7016, 7028, 7048, 7137, 7138, 7367, 7678, 7689, and SL-series crosslinkers), and those available from Gelest, Inc.

Condensation cure silicone systems that contain both one or more silanol-terminated polyorganosiloxane(s) and one or more hydride-functional silane crosslinkers are also known. Examples of such systems include those available from Dow Corning Corporation, including those available under the trade names SYL-OFF (e.g., SYL-OFF 292 and SYL-OFF 294).

As is known by one of ordinary skill in the art, the relative amounts of the hydroxyl-functional polyorganosiloxane(s) and the hydride-functional silane(s) can be selected to obtain a variety of use compositions. Factors effecting such selections include the specific polyorganosiloxane(s) and silane(s) selected, the relative functionality of the silane(s) compared to the polyorganosiloxane(s), the desired degree of cross-linking and/or chain extension, and the desired final properties including e.g., release force, mechanical properties, cure conditions, percent extractables, and the like. Generally, the relative amounts are selected such that ratio of molar equivalents of hydroxyl functionality to molar equivalents of hydride functionality is between 0.01 and 10, inclusive, e.g., between 0.04 and 2, inclusive.

The compositions of the present disclosure include a catalyst. Traditionally, tin catalysts—such as dibutyltin diacetate—have been used to catalyze condensation-cure silicone systems. However, the present inventors discovered that platinum complexes, including Pt(0) complexes, Pt(II) complexes, and Pt(IV) complexes are efficient catalysts for these very same condensation-cure silicone systems.

In some embodiments, the compositions comprise at least one Pt(0) complex. In some embodiments, the Pt(0) complex is bis-(1,3-divinyl-1,1,3,3-tetramethyldisiloxane) platinum (0) (commonly known as Karstedt catalyst). Other exemplary Pt(0) complexes suitable for use in some embodiments include (2,4,6,8-tetramethyl-2,4,6,8-tetravinylcyclotetrasiloxane) platinum(0), ethylenebis(triphenylphosphine)platinum(0), bis(tri-tert-butylphosphine) platinum(0), and tetrakis(triphenylphosphine) platinum(0).

In some embodiments, the compositions comprise at least one Pt(II) complex. In some embodiments, the Pt(II) complex is dimethyl (1,5-cyclooctadiene)platinum(II). Other exemplary Pt(II) complexes suitable for use in some embodiments include trans-dichlorobis(triethylphosphine) platinum(II), dichlorobis(ethylenediamine) platinum(II), dichloro(1,5-cyclooctadiene) platinum(II), platinum(II) chloride, platinum(II) bromide, platinum(II) iodide, trans-platinum(II)diammine dichloride, dichloro(1,2-diaminocyclohexane) platinum(II), and ammonium tetrachloroplatinate(II).

In some embodiments, the compositions comprise at least one Pt(IV) complex. In some embodiments, the Pt(IV) complex is dihydrogen hexachloroplatinate (IV) hexahydrate. Other exemplary Pt(IV) complexes suitable for use in some embodiments include platinum(IV) oxide hydrate, and ammonium hexachloroplatinate(IV).

Generally, the amount of catalyst present will be at least 1 part per million (ppm) precious metal based on the total weight of the hydroxyl-functional polyorganosiloxane and the hydride-functional silane, e.g., at least 5 ppm, or even at least 10 ppm. In some embodiments, the composition comprises 5 to 200 ppm of the precious metal based on the total weight of the hydroxyl-functional polyorganosiloxane and the hydride-functional silane, e.g., 5 to 100 ppm, 10 to 100 ppm, or even 10 to 50 ppm.

Examples. Unless otherwise noted, all parts, percentages, ratios, etc., in the examples and in the remainder of the specification are by weight. Unless otherwise noted, all chemicals were obtained from, or are available from, chemical suppliers such as Sigma-Aldrich Chemical Company, St. Louis. Mo.

“Silicone-A” is a 30 weight percent solids dispersion of a blend of reactive hydroxysilyl-functional siloxane polymer(s) (said to comprise hydroxyl-terminated polydimethylsiloxane) and hydrosilyl-functional polysiloxane crosslinker (said to comprise poly(methyl)(hydrogen)siloxane) in xylene (a composition obtained from Dow Corning Corporation, Midland, Mich., under the trade designation SYL-OFF 292).

“Silicone-B” is a 40 weight percent solids dispersion of a blend of reactive hydroxysilyl-functional siloxane polymer(s) (said to comprise hydroxyl-terminated polydimethylsiloxane) and multifunctional crosslinkers (said to comprise poly(methyl)(hydrogen)siloxane) in naptha petroleum solvent (obtained from Dow Corning Corporation, under the trade designation SYL-OFF 294).

“Silicone-C” is a silanol-terminated polyorganosiloxane, obtained from Dow Corning Corporation under trade designation DOW CORNING 3-0134 POLYMER 50 000 CST.

“Silicone-D” is a silanol-terminated polyorganosiloxane, obtained from Dow Corning Corporation under trade designation DOW CORNING 3-0135 POLYMER.

“Silicone-E” is a 29 percent solids dispersion of silanol terminated polydimethylsiloxane gum in toluene, obtained from Momentive Performance Materials, Columbus, Ohio, under the trade designation SS-4191A.

“XLINK-1” is a 100% solids silane crosslinker (said to comprise methylhydrogen cyclosiloxane, obtained from Dow Corning Corporation under trade designation SYL-OFF 7048).

“XLINK-2” is a solventless polymethylhydrogensiloxane crosslinker, obtained from Momentive Performance Materials, Columbus, Ohio, under the trade designation SS-4300C.

“XLINK-3” is a silanol-functional (4.0-6.0% OH) poly(methylsilsesquioxane), obtained from Gelest, Inc., Morrisville, Pa., under trade designation SST-3M01.

“XLINK-4” is a bis(triethoxysilyl)ethane (alternatively known as hexaethoxydisilethylene), obtained from Gelest, Inc., Morrisville, Pa., under trade designation SIB1817.0.

“SYL-OFF C4-2109” is the trade name of a release additive that is a 10 percent solids dispersion of a silicone resin in xylene, obtained from Dow Corning Corporation, Midland, Mich.

“Cat-Tin” is dibutyltin diacetate, obtained from Dow Corning Corporation, Midland, Mich., under trade designation DOW CORNING 176 CATALYST.

“Cat-Pt(0)” is platinum(0)-1,3-divinyl-1,1,3,3-tetramethyldisiloxane (2 wt % platinum in xylene) was purchased from Sigma-Aldrich Chemical Company, and kept in the dark before use.

“Cat-Pt(II)” is dimethyl (1,5-cyclooctadiene)platinum(II) was purchased from Sigma-Aldrich Chemical Company, and kept in the dark before use.

‘Cat-Pt(IV)” is dihydrogen hexachloroplatinate (IV) hexahydrate was purchased from Sigma-Aldrich Chemical Company, and kept in the dark before use.

Heptane and methylethylketone (MEK) were purchased from Sigma-Aldrich Chemical Company, St. Louis. Mo. and used as received.

Silicone Coat Weight Procedure. Silicone coat weights were determined by comparing approximately 3.69 cm diameter samples of coated and uncoated substrates using an EDXRF spectrophotometer (obtained from Oxford Instruments, Elk Grove Village, Ill. under trade designation OXFORD LAB X3000).

Silicone Extractables Procedure. Unreacted silicone extractables were measured on cured thin film formulations to ascertain the extent of silicone crosslinking. The percent extractable silicone, (i.e., the unreacted silicone extractables), a measure of the extent of silicone cure on a release liner, was measured by the following method.

The silicone coat weight of a 3.69 cm diameter sample of coated substrate was determined according to the Silicone Coat Weight Procedure. The coated substrate sample was then immersed in and shaken with methyl isobutyl ketone (MIBK) for 5 minutes, removed, and allowed to dry. The silicone coating weight was measured again according to the Silicone Coat Weight Procedure. Silicone extractables were attributed to the weight difference between the silicone coat weight before and after extraction with MIBK as a percent using the following formula:

(a−b)/a*100=Percent Extractable Silicone
wherein a=initial coating weight (before extraction with MIBK); and
wherein b=final coating weight (after extraction with MIBK).

Kinetic Coefficient of Friction Procedure. The coefficients of friction of the release liners were measured in the following manner, which is in general accordance to ASTM-D 1894.

A sample of release liner was cut to approximately 10.16 cm×20.32 cm (4″×8″) in size and secured the platform of an IMASS slip/peel tester (Model SP-102B-3M90, obtained from Instrumentors, Incorporated, Strongsville, Ohio) such that the silicone-coated surface was exposed. The sample surface and the friction-sled were blown with compressed air to remove any loose dust, the friction-sled was placed on the silicone surface, and the chain attached to the sled was affixed to the force transducer of the IMASS Slip/Peel tester. The platform of the IMASS Slip/Peel tester was set in motion at a speed of 38 cm/minute. The instrument calculated and reported the average kinetic friction force, omitting the static frictional force. The kinetic coefficient of friction was obtained by dividing the kinetic frictional force by the weight of the friction sled. In general, non-tin catalyzed silicone release systems have a high coefficient of friction (COF>0.8) as compared to solvent-delivered tin condensation-cure silicone release systems (COF<0.3).

Viscosity Procedure. Viscosity measurements were performed with a Brookfield Viscometer procured from Brookfield Engineering Laboratories, Inc. MA USA. Samples were prepared and measured in 150-mL jars. Precaution was taken to ensure that solution reach the indent on the spindle when measuring. Different spindles, for example spindle #3, 4, or 6 were made to spin at a predetermined rate and their corresponding speed-values were recorded. Viscosity was calculated by multiplying the speed-value with the appropriate spindle factor and reported in centistrokes.

The following examples illustrate the catalytic effect of platinum in condensation cure systems comprising both silanol-functional polyorganosiloxanes and silicon hydride-functional silanes.

Example 1 (EX-1) and Comparative Example 1 (CE-1) were prepared using the same silicone formulation except that EX-1 contained a platinum complex catalyst while CE-1 contained a tin catalyst typical of the prior art. Each silicone composition contained 0.3155 grams (g) Silicone-A, 0.4201 g Silicone-E, 0.1597 g SYL-OFF C4-2109 release additive, and 0.00429 g XLINK-2; and was diluted with 5.6 g heptane and 3.5 g MEK. Cat-Pt(0) was added to the composition of EX-1 in an amount sufficient to provide 200 ppm platinum based on the total weight of the composition. CAT-Tin (0.008 g) was added to the composition of CE-1.

Samples of EX-1 and CE-1 were coated on 58# corona-treated, polyethylene-coated kraft paper (PCK, obtained from Jen-Coat, Inc., Westfield, Mass.) with a #5 Mayer bar. The coatings were dried and cured at 110 ° C. for two minutes in an oven equipped with solvent exhaust. Neither EX-1 nor CE-1 smeared when rubbed, a qualitative indication that the compositions were cured. The samples were evaluated according to the Silicone Extractables Procedure, the Kinetic Coefficient of Friction Procedure, the Adhesive Wettability Procedure, and the Adhesive Build-up Procedure. The results are summarized in Table 1.

TABLE 1
Comparison of Example EX-1 (Platinum)
and Comparative Example CE-1 (Tin).

| Test | EX-1 | CE-1 |
|---|---|---|
| Silicone extractables (wt. %) | 11.5 | 12.7 |
| Kinetic coefficient of friction | 0.21 | 0.24 |

Examples 2-8 (EX-2 through EX-8) were prepared by combining Silicone-A or Silicone-B with a platinum catalyst, coating the composition of 58# and curing the composition on corona-treated, polyethylene-coated kraft paper with a Mayer bar, and drying and curing the composition at 110° C. for two minutes in an oven equipped with solvent exhaust. None of the samples smeared when rubbed after curing. Each sample was evaluated according to the Silicone Extractables Procedure immediately after curing. The compositions and results of these tests are summarized in Table 2.

TABLE 2
Summary of Examples EX-2 through EX-8.

| | | | Solvent | | | | | |
|---|---|---|---|---|---|---|---|---|
| | Silicone | | Heptane | MEK | Catalyst | | Mayer | Silicone Extr. |
| Example | ID | grams | (g) | (g) | ID | ppm | bar | (wt. %) |
| EX-2 | B | 3.0 | 10.39 | 6.61 | Cat-Pt(0) | 70 | #4 | 10.7 |
| EX-3 | B | 3.0 | 10.39 | 6.61 | Cat-Pt(0) | 80 | #4 | 5.6 |
| EX-4 | A | 3.0 | 12 | — | Cat-Pt(0) | 100 | #5 | 10.6 |
| EX-5 | A | 3.0 | 12 | — | Cat-Pt(0) | 250 | #5 | 2.7 |
| EX-6 | A | 3.0 | 12 | — | Cat-Pt(IV) | 300 | #4 | 7.5 |
| EX-7 | A | 3.0 | 12 | — | Cat-Pt(IV) | 700 | #4 | 1.8 |
| EX-8 | A | 3.0 | 12 | — | Cat-Pt(II) | 250 | #4 | 6.5 |

The following examples illustrate the catalytic effect of platinum in condensation cure systems comprising only silanol-functional materials.

Example 9 (EX-9) was prepared by mixing 100 g Silicone-D (a silanol-terminated polyorganosiloxane) and Cat-Pt(IV) (500 ppm Pt) in a 150 mL beaker. Comparative Example 2 (CE-2) consisted of 100 g Silicone-D, also in a 150 mL beaker. These mixtures were held at 70° C. and stirred with and overhead stirrer. The silanol-silanol condensation reaction was monitored by measuring the viscosity of the formulations every four hours for twenty-four hours according to the Viscosity Procedure. The results are summarized in Table 3.

TABLE 3
Comparison of Example EX-9 and Comparative Example CE-2.

| | |
|---|---|
| Time | Viscosity (centistokes) |

| (hours) | EX-9 | CE-2 |
|---|---|---|
| 0 | 14,000 | 14,000 |
| 4 | 23,000 | 14,100 |
| 8 | 29,000 | 14,900 |
| 12 | 37,000 | 15,700 |
| 16 | 39,000 | 15,900 |
| 20 | 39,200 | 16,400 |
| 24 | 40,400 | 16,800 |

Example 10 was prepared by combining 5 g of Silicone-C (a silanol-terminated polyorganosiloxane), 5 g XLINK-3, and Cat-Pt(IV) (500 ppm Pt) in a 50 mL beaker. The mixture was heated to 120° C. and intermittently stirred for one hour. Crosslinking of the materials was accomplished through silanol-silanol condensation.

Example 11 was prepared by combining 8 g of Silicone-C (a silanol-terminated polyorganosiloxane), 2 g XLINK-4, and Cat-Pt(IV) (500 ppm Pt) in a 50 mL beaker. Water (0.5 mL) was added to facilitate the formation of silanol functionality on the bis(triethoxysilyl)ethane. The mixture was heated to 120° C. and intermittently stirred for one hour. Crosslinking of the materials was accomplished through silanol-silanol condensation.

Example 12 was prepared by combining 0.3155 g Silicone-B, 0.4201 g Silicone-E, 0.1597 g SYL-OFF C4-2109 release additive, 0.07 g XLINK-4, and 0.00429 g XLINK-2; and diluting the mixture with 5.6 g heptane and 3.5 g MEK. Cat-Pt(0) was added (500 ppm Pt) was then added to the composition. The resulting formulation was coated on 58# corona-treated, polyethylene-coated kraft paper with a #5 Mayer bar. The coating was dried and cured at 110° C. for five minutes in an oven equipped with solvent exhaust. The cured coating showed no smear upon rubbing. The sample contained 8.2 wt. % extractable as evaluated according to the Silicone Extractables Procedure performed immediately after coating. This level of extractables, which was obtained in a formulation containing both a silane crosslinker and an alkoxy-containing crosslinker, was lower than the silicone extractables obtained in Example EX-1.

When cured, the condensation-cure systems of the present disclosure may be suitable for a wide variety of applications. In some embodiments, the cured compositions may be suitable as release layers for release liners. In some embodiments, such liners may be suitable for use with an adhesive article.

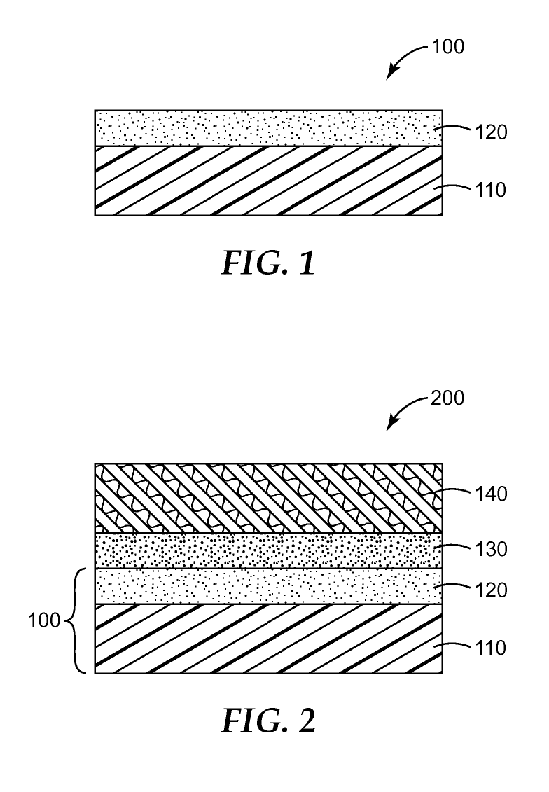

An exemplary release article 100 according to some embodiments of the present disclosure is illustrated in FIG. 1. Release article 100 includes release layer 120 and substrate 110. In some embodiments, release layer 120 is directly bonded to substrate 110. In some embodiments, one or more layers, e.g., primer layers, may be located between release layer 120 and substrate 110. Any known material may be suitable for use in substrate 110 including paper and polymeric films. Any of the compositions of the present disclosure may coated on such substrates and cured to provide the release layer. Conventional coating and curing methods are well known, and one of ordinary skill in the art may select those appropriate for the selected condensation-cure composition and substrate selected.

An exemplary adhesive article 200 incorporating release article 100 is shown in FIG. 2. Adhesive layer 130 is in direct contact with the surface of release layer 120, opposite substrate 110. Generally, any known adhesive may be used and one of ordinary skill in the art can select an adhesive appropriate for the selected release layer. In some embodiments, acrylic adhesives may be used. In some embodiments, adhesive article 200 may also include optional layer 140, which may be adhered directly to adhesive layer 130, opposite release layer 120. In some embodiments, one or more intervening layers, e.g., primer layers, may be present between adhesive layer 130 and optional layer 140. Optional layer 140 may be any of a wide variety of known materials including paper, polymeric film, foam, woven and nonwoven webs, scrims, foils (e.g., metal foils), laminates, and combinations thereof.

The coated samples prepared from the compositions of comparative example CE-1 and examples EX-1 through EX-8 were evaluated as release liners according to the Release Liner Adhesion Procedure. This test was used to measure the effectiveness of release liners prepared using the compositions according to the examples and comparative examples described herein that had been aged for a period of time at a constant temperature and relative humidity. The aged release value is a quantitative measure of the force required to remove a flexible adhesive from the release liner at a specific angle and rate of removal. The results are summarized in Table 4.

Release Liner Adhesion Procedure. The 180 degree angle peel adhesion strength of a release liner to an adhesive was measured in the following manner, which is generally in accordance with the test method described in Pressure Sensitive Tape Council PSTC-101 method D (Rev 05/07) “Peel Adhesion of Pressure Sensitive Tape.” Sample release liners were dry laminated with an acrylic adhesive coating using an adhesive transfer tape. The adhesive transfer tape was prepared by coating an acrylic radiation-sensitive syrup using a notched bar coater to form a continuous web of acrylic syrup nominally 50 micrometers thick. The resulting coated web was then polymerized to more than 95 percent conversion by exposing the acrylic syrup to UV-A irradiation from 20 W 350BL lamps (available from Osram Sylvania, Danvers, Mass.) in a nitrogen-inerted environment. Upon curing, the polymerized syrup formed a pressure-sensitive adhesive transfer tape, which was laminated to the sample release liners to make adhesive transfer tapes.

The adhesive transfer tapes were aged for seven days at 23° C. and 50% relative humidity. After aging, a 2.54 cm wide by approximately 20 cm in length sample of the adhesive transfer tape was cut using a specimen razor cutter. The cut sample was applied with its exposed adhesive surface down and lengthwise onto the platen surface of a peel adhesion tester (Slip/Peel Tester, Model 3M90, obtained from Instrumentors, Incorporated, Strongsville, Ohio). The applied sample was rubbed down on the test panel using light thumb pressure. The adhesive transfer tape on the platen surface was then rolled twice with a 2 kg rubber roller at a rate of 61 cm/minute.

Next, the sample release liner was carefully lifted away from the adhesive layer adhered to the platen surface, doubled-back at an angle of 180 degrees, and secured to the clamp of the peel adhesion tester. The 180 degree angle release liner peel adhesion strength was then measured as the liner was peeled from the adhesive at a rate of 38.1 mm/second. A minimum of two test specimens were evaluated with results obtained in g/inch which were used to calculate the average peel force. This was then converted to Newtons per meter (N/m). All release tests were carried out in a facility at constant temperature (23° C.) and constant relative humidity (50 percent).

TABLE 4
Peel adhesion for samples CE-1 and EX-1 through EX-8.

| | Peel Adhesion |
|---|---|
| Sample | (N/m) |
| CE-1 | 19.3 |
| EX-1 | 25.7 |
| EX-2 | 23.1 |
| EX-3 | 30.1 |
| EX-4 | 26.5 |
| EX-5 | 27.8 |
| EX-6 | 26.4 |
| EX-7 | 27.9 |
| EX-8 | 24.7 |

The peel adhesions obtained with the platinum-catalyzed systems (EX-1 through EX-8) were comparable to the peel adhesion for a traditional tin-catalyzed system (CE-1).

In some embodiments, the compositions of the present disclosure may include one or more inhibitors. Such inhibitors can extend the shelf-life and/or pot life of the product. For example, catalyzed silicone systems are known to gel prematurely, and the addition of an inhibitor may be used to minimize this effect. Suitable inhibitors include, e.g., dialkyl and dialkenylcarboxylic esters such as maleate esters (e.g., diallylmaleate and dimethylmaleate) and fumerate esters; and alkynols. Other known inhibitors that may be useful in some embodiments include acetylene dicarboxylates, amines, isocyanurates, ene-ynes, and vinyl acetates.

Various modifications and alterations of this invention will become apparent to those skilled in the art without departing from the scope and spirit of this invention.

1. A condensation-cure system comprising at least one silanol-functional polyorganosiloxane and a platinum catalyst.

2. The condensation-cure system of claim 1, wherein the platinum catalyst comprises at least one of a Pt(0) complex, a Pt(II) complex, and a Pt(IV) complex.

3. The condensation-cure system of claim 2, wherein the platinum catalyst is platinum(0)-1,3 -divinyl-1,1,3,3 -tetramethyldisiloxane.

4. The condensation-cure system of claim 2, wherein the platinum catalyst is dimethyl (1,5-cyclooctadiene)platinum(II).

5. The condensation-cure system of claim 2, wherein the platinum catalyst is dihydrogen hexachloroplatinate (IV) hexahydrate.

6. The condensation-cure system according to claim 1 further comprising two or more silanol-functional polyorganosiloxanes.

7. The condensation-cure system according to claim 1 further comprising a hydride-functional silane.

8. The condensation-cure system according to claim 1 further comprising an alkoxy-functional silane.

9. The condensation-cure system according to claim 1 further comprising at least 20 wt. % solvent.

10. The condensation-cure system according to claim 1 further comprising an inhibitor.

11. The condensation-cure system according to claim 10, wherein the inhibitor is selected from the group consisting of maleate esters, fumarate esters, alkynols, and combinations thereof.

12. An article comprising a crosslinked silicone layer comprising the reaction product of the condensation-cure system according to claim 1.

13. The article of claim 12, further comprising a substrate, wherein the crosslinked silicone layer covers at least a portion of a first surface of the substrate.

14. The article of claim 13, further comprising an adhesive layer, wherein the adhesive layer covers at least a portion of the crosslinked silicone layer.
